(19) United States
(12) Patent Application Publication
(10) Pub. No.: US 2010/0215236 A1
(43) Pub. Date: Aug. 26, 2010

(54) METHOD OF RECONSTRUCTING IN THREE DIMENSIONS A SINGULAR OBJECT ON THE BASIS OF IMAGING IN SECTION (SCANNER, MRI)

(75) Inventors: Erwan Jolivet, Paris (FR); Jean-Denis Laredo, Paris (FR); Wafa Skalli, Paris (FR); David Mitton, Le Kremlin-Bicetre (FR)

Correspondence Address: Muncy, Geissler, Olds & Lowe, PLLC, 4000 Legato Road, Suite 310, FAIRFAX, VA, 22033, US

(73) Assignees: CENTRE NATIONAL DE LA RECHERCHE SCIENTIFIQUE, Paris (FR); ECOLE NATIONALE SUPERIEURE D'ARTS ET METIERS (ENSAM), Paris (FR)

(21) Appl. No.: 12/675,616

(22) PCT Filed: Aug. 1, 2008
(86) PCT No.: PCT/FR08/01148

§ 371 Date: Apr. 8, 2010

(30) Foreign Application Priority Data
Aug. 29, 2007 (FR) 07 06048

(51) Int. Cl. G06K 9/62

(52) U.S. Cl. 382/131

(57) ABSTRACT

A method of three-dimensionally reconstituting the shape of a singular body in a reference coordinate system and on the basis of initial imaging data acquired by an imaging system of the scanner or MRI type, wherein the method includes the steps of, constituting an approximate three-dimensional model of the singular body on the basis of a parameterizable generic model that is modified as a function of descriptive parameters derived from said initial data, and correcting the approximate model by comparing it (2) with the initial imaging data (D).

The present invention relates to a method of three-dimensionally reconstructing a singular object on the basis of a series of two-dimensional measurements of said body.

### BACKGROUND OF THE INVENTION

Knowledge of the three-dimensional geometry of a singular body is useful in numerous fields, and in particular in the fields of medicine and surgery.

Scanner or MRI type medical imaging makes it possible to acquire data identified in a coordinate system in a predetermined volume, from which data it is possible, by appropriate processing, to obtain two-dimensional X-ray views of an internal structure of the human body.

At present, three-dimensional reconstitution of bony structures from such data requires numerous manual operations to be performed, since image processing algorithms do not have sufficiently high performance. In certain circumstances, it can even happen that the initial data does not enable such reconstitution to be achieved since the image processing technique (in particular segmentation) fails.

Methods and devices are known that make it possible, on the basis of multiple plane X-rays of a body associated with a priori knowledge of a generic model for said body, to proceed by means of algorithms for processing the mathematical objects represented by the X-rays and the generic model, with three-dimensional reconstitution of the X-rayed object. That technique is described in particular in documents FR 2 810 769 and FR 2 856 170. That technique is not suitable for reconstruction on the basis of MRI or scanner images, since those imaging techniques provide image sections having a certain thickness. Nevertheless, such MRI or scanner images make it possible to obtain approximate values for certain parameters describing the geometry of the singular body, which values often enable parameters of a generic model to be set in satisfactory manner.

Starting from the observation that in each surgery center, and in particular in each center for orthopedic surgery, MRI imaging or scanner type equipment is already available, the present invention seeks to provide means for reconstituting the three-dimensional shape of an object, in particular a bony object, in a manner that is fast, i.e. in a length of time that is compatible with the normal preparation for surgery so that the result of the reconstitution can be used prior to surgery as a medium for or as an aid to diagnosis or selecting a procedure, or can be used during surgery as a reference element, e.g. for introducing into a navigation system.

### SUMMARY OF THE INVENTION

The present invention provides a method of three-dimensionally reconstituting the shape of a singular body in a reference coordinate system and on the basis of initial imaging data acquired by an imaging system of the scanner or MRI type, wherein the method comprises the following steps:

constituting an approximate three-dimensional model of the singular body either in the form of a geometrical representation of its surface or in the form of a mesh of finite elements and on the basis of a parameterizable generic model that is modified as a function of descriptive parameters derived from said initial data; and

correcting the approximate model by comparing it with the initial imaging data.

By three-dimensionally reconstituting an approximate model of the singular body, the invention makes it possible to process any singular body that may be presented, unlike known methods. Certain circumstances exist that are unsuitable for being processed by image segmentation. In methods making use of a database of three-dimensional reconstituted bodies, certain situations can arise that cannot be approximated by any of the elements in the database. Thus, a surgeon may be left without a reconstitution of the singular body, and that is not satisfactory.

In a first implementation of the invention, the step of constituting the approximate three-dimensional model consists in making two simulated radiographs of the body (FIGS. 2A and 2B) by projecting the initial data onto two planes that are not parallel with each other but that are parallel with a determined straight line in the coordinate system, and in associating them with the generic model by means of appropriate algorithms.

This method provides the advantage of presenting the imaging data in the form of two plane data collections that can be processed like two radiographs obtained from two different non-parallel points of view, with the speed and reliability that are nowadays well established in stereoradiography.

In another implementation, the step of constituting the approximate three-dimensional model consists in applying parameter values to the parameterizable generic model, which values describe the geometry of the singular body as derived directly in approximate manner from the initial data.

Other characteristics and advantages of the invention appear from the description given below of an implementation of the method of the invention.

### BRIEF DESCRIPTION OF THE DRAWINGS

Reference is made to the accompanying drawings, in which:

FIG. 1 is a diagram showing various planes in a data volume obtained by conventional imaging of the scanner or magnetic resonance imaging (MRI) type, the planes being stacked in a privileged direction (axial, vertical) in the coordinate system of this volume;

FIGS. 2A and 2B are diagrams of two orthogonal radiographs simulated by projecting initial data of the imaging in two mutually perpendicular directions that are perpendicular to the above-mentioned privileged direction;

FIG. 3 is a three-dimensional (3D) representation of the body (pelvis) that was subjected to the initial imaging, as obtained by any of the treatment methods that are known in the context of stereoradiography;

FIG. 4 shows parameter values marked on a scanner image, which values are descriptive of the geometry of the singular body;

FIG. 5 shows a parameterized generic model using the values taken from FIG. 4; and

FIGS. 6A, 6B, and 6C show the final stage of three-dimensional reconstruction of the body that was subjected to the initial imaging.

### DETAILED DESCRIPTION OF THE INVENTION

The data acquired by conventional imaging from a scanner or MRI is in a form as shown in FIG. 1. This form comprises a data set situated in identified manner in a determined volume V that can be extracted by processing on a plurality of parallel planes 1a, 1b, . . . so as to present the practitioner with tomographic-type images of the explored zone. In the present description, the body being observed is the pelvic bone.

The planes 1a, 1b, . . . , 1i, . . . are perpendicular to a general direction of the coordinate system of the volume, this direction being vertical and corresponding to the position of the pelvis when the subject is standing.

In the invention, the acquired data is processed so as to create a projection of the pelvis in the antero-posterior direction (arrow A) onto a plane that is parallel to the above-mentioned vertical direction, and a second projection of the pelvis in the lateral direction (arrow B) onto another plane that is likewise parallel to said direction.

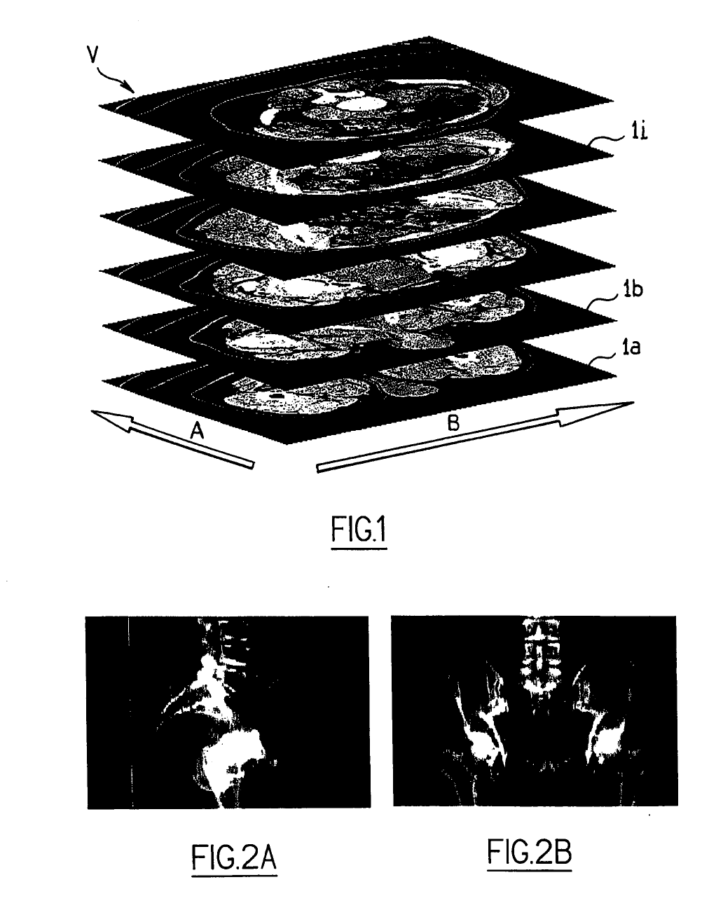

The images that result from this processing are shown in FIG. 2A (projection in the antero-posterior direction) and 2B (projection in the lateral direction). It can be understood that such projections are similar to orthogonal radiographs of the pelvis of the kind that can be obtained using specialist appliances in the state of the art mentioned in the introduction.

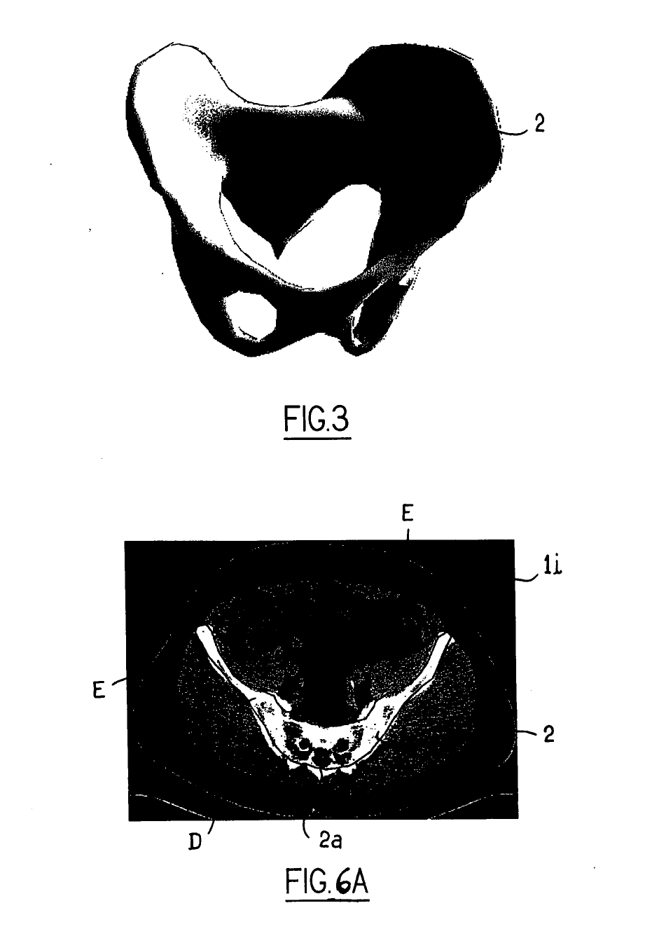

These simulated radiographs make it possible with the help of processing algorithms, which also form part of the state of the art and which include generic models or data banks, to proceed with a three-dimensional reconstruction of a first model 2 of the pelvis, as shown in FIG. 3. This “initial” model is merely an approximation to the real shape of the pelvis that is to be reconstructed.

Thus, according to the invention, the reconstruction method is refined by incorporating said first reconstruction in the data volume V obtained by the conventional imaging and by proceeding with correction by means of image-processing algorithms. This first reconstruction then acts as a generic model in the processing, in like manner to that which is known in performing three-dimensional reconstruction of the shape of a body by using prior art techniques.

FIG. 4 is a scanner image of a pelvis in a frontal plane carefully selected so that it is possible from said image to determine approximate values that are very close to reality for parameters that describe the scanned pelvis. By way of example, these values are the radii of the cups (acetabula) of the femur head joints, referenced R in FIG. 4, the distance D1 between their centers O, the distances D2 and D3 between each center O of and each iliac crests, and the distance D4 between the iliac crest. The distances D1 to D4 are approximate since they are, in fact, projections of those distances onto the viewing plane.

FIG. 5 shows a generic model of the pelvis with certain parameters that can be set. This three-dimensional parameterizable generic model has its parameters set in the form of a mesh of finite elements and its outside surface is described by a known method similar to that described in FR 2 901 043. The generic model thus has its parameters set, e.g. by fixing values for the positions of the centers O and for the segments R and D1 to D4. This provides an initial model 2 that is of the type shown in FIG. 3. Naturally, it is possible to proceed in the same manner by acting on a geometrical representation of its surface.

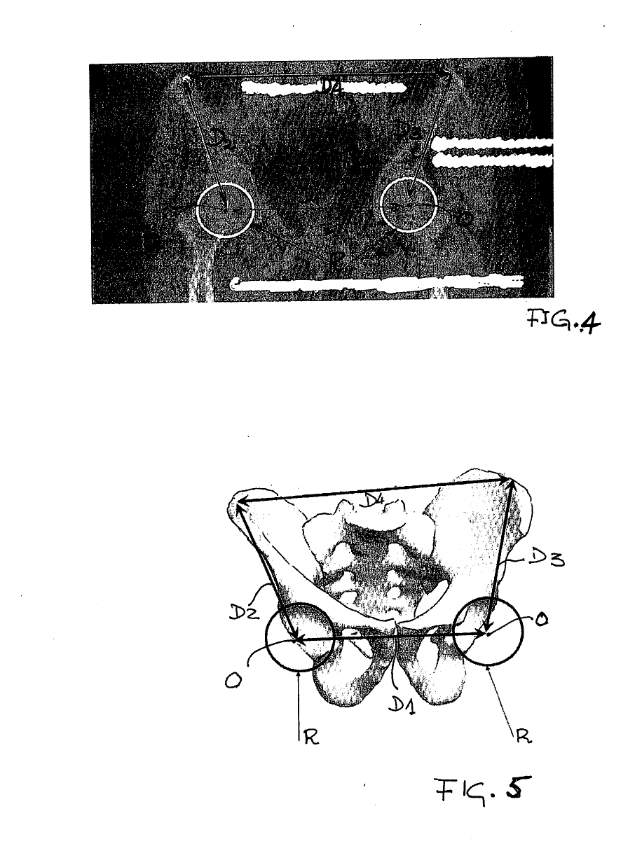

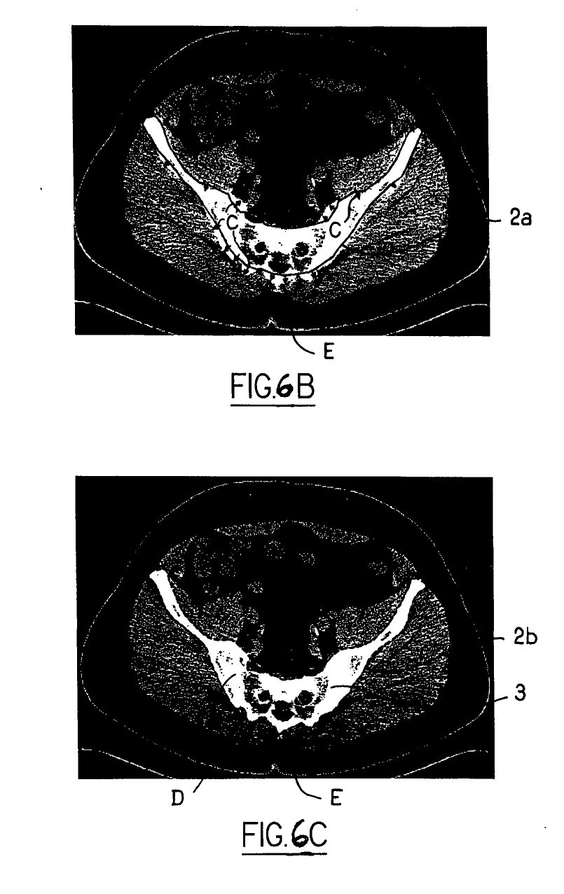

FIG. 6A is a representation on a plane 1i such as the planes 1a or 1b, . . . in which the initial model 2 as reconstructed is superposed on the data D as acquired in the volume V in said plane. The algorithms used make it possible to determine the outer envelope E of the bone. By analyzing the differences between the outline 2a of the model 2 in the plane 1i and the outer envelope E in said plane of the radiographed bone, it is possible to deform the outside surface of the initial model 2 so as to proceed with finalizing the personalization of the reconstruction. In FIG. 6B, arrows C show the directions of the deformations to be applied. This technique is also known and relies on control points or outlines that are defined in the documents mentioned in the introduction of the present description, amongst others. This correction of the object is not necessarily performed in the section planes, for example if the directions of the deformations are normal to the surface of the reconstructed object and do not lie in said plane.

Once the deformation has been applied, it can be seen that the outline 2b of the deformed initial model 3 perfectly matches the data acquired by the imaging technique used. FIG. 6C illustrates this result.

A reconstruction of the pelvis is thus made available that is identical to the subject's bone, the reconstruction being digitized and thus suitable for being processed in various ways in utilizations for diagnostic purposes or for selecting surgical procedures or suitable for introducing into navigation software in order to assist a practitioner during surgery.

The mathematical processing of the data by the above-mentioned algorithms is performed by a computer that possesses a peripheral for displaying the result of the processing. The computer also has memories, data banks, and software enabling the various computations to be performed in a relatively short length of time, with this remaining compatible with the preparatory stages prior to undertaking orthopedic surgery. The system also leaves room for manual intervention, in particular concerning operations of refining the shape of the model.

Naturally, the invention is not limited to the embodiment described and implementation variations may be applied thereto without going beyond the ambit of the invention as defined by the claims.

In particular, in a variant, the correction may be performed in non-automatic manner by an operator.

What is claimed is:

1. A method of three-dimensionally reconstituting the shape of a singular body in a reference coordinate system (V) and on the basis of initial imaging data acquired by an imaging system of the scanner or MRI type, wherein the method comprises the following steps:
constituting an approximate three-dimensional model of the singular body on the basis of a parameterizable generic model that is modified as a function of descriptive parameters derived from said initial data; and
correcting the approximate model by comparing it (2) with the initial imaging data (D).

2. The method of three-dimensional reconstitution according to claim 1, wherein the step of constituting the approximate three-dimensional model consists in making two simulated radiographs of the body by projecting the initial data onto two planes that are not parallel with each other but that are parallel with a determined straight line in the coordinate system, and in associating them with the generic model by means of appropriate algorithms.

3. The method of three-dimensional reconstitution according to claim 1, wherein the step of constituting the approximate three-dimensional model consists in applying parameter values (R, O, D1-D4) to the parameterizable generic model, which values describe the geometry of the singular body as derived directly in approximate manner from the initial data.

4. The method according to claim 2, wherein the correction is performed by applying image processing algorithms in which the approximate model is used as a generic model.
